(19) United States
(12) Patent Application Publication
(10) Pub. No.: US 2011/0075396 A1
(43) Pub. Date: Mar. 31, 2011

(54) SYSTEM INTEGRATED SOUND BROADCAST AND ILLUMINATION AND METHOD THEREOF

(76) Inventor: Chun-I SUN, Taipei County (TW)

(21) Appl. No.: 12/870,303

(22) Filed: Aug. 27, 2010

(30) Foreign Application Priority Data
Sep. 29, 2009 (TW) 098132836

(51) Int. Cl. H04M 1/22

(52) U.S. Cl. 362/86

(57) ABSTRACT

The present invention relates to a system integrated sound broadcast and illumination and method thereof. The method includes the steps of: providing a plurality of illumining apparatuses, wherein each illumining apparatus includes a speaker and a sensing element; determining whether a user is opposite to one of the illumining apparatuses; and transmitting an audio signal to a speaker of a specific illumining apparatus when a sensing element of the specific illumining apparatus senses a user opposite to the specific illumining apparatus. Therefore, the speaker of the specific illumining apparatus plays audio according to the audio signal.

This application claims priority of No. 098132836 filed in Taiwan R.O.C. on 2009 Sep. 29 under 35 USC 119, the entire content of which is hereby incorporated by reference.

### BACKGROUND OF THE INVENTION

1. Field of Invention

The invention relates to the technology associated with a kind of home applications, and more particularly to a system integrated sound broadcast and illumination and a method thereof.

2. Related Art

In recent years listening music is gradually becoming a daily amusement. Besides better speaker or other audio apparatuses, users get fussier and fussier about acoustics. In order to pursue the realistic acoustics and the better quality stereo, more speakers must be set in the room. For space-saving, there are designs to integrate speakers into domestic decoration in modern times.

FIG. 1 is a diagram depicting a design of domestic decoration combines speaker and illumination provided by the prior art of U.S. Pat. No. 7,535,341 B2. Referring to FIG. 1, this apparatus includes four tweeters 50, 52, 54, 56, a bass 40 and a plurality of light emitting diodes 60. The tweeters 50, 52, 54, 56 are disposed around the bass 40. The light emitting diodes 60 are disposed in the fixing devices 32 respectively around the bass 40, wherein the fixing devices 32 are perpendicular to the bass 40.

Although above mentioned U.S. Pat. No. 7,535,341 B2 provides a space-saving speaker, it cannot satisfied the users because they go around in the house in daily life. The location of the bass 40 would not affect the quality of acoustics because the bass (lower than 200 Hz) is non-directional. However, the high pitched voice is directional. In other words, if the tweeter does not aim at the listener, the stereo cannot be formed. Thus, it would make a great effect on the acoustics.

### SUMMARY OF THE INVENTION

An object of the invention is to provide a system integrated sound broadcast and illumination for furnish a user with a living environment in stereo.

Another object of the invention is to provide a method integrated sound broadcast and illumination for playing music with the user in a living environment.

To achieve the above-identified or other objects, the invention provides a system integrated sound broadcast and illumination comprising a plurality of illumining apparatuses and a controller. Each illumining apparatus comprises a speaker and a sensing element. The speaker is set in the illumining apparatus. The sensing element is set in the illumining apparatus for sensing the temperature of the passing object opposite to the illumining apparatus. The controller is coupled to all the above mentioned illumining apparatuses. When the sensing element of a specific illumining apparatus of the illumining apparatuses senses a user which is opposite to the illumining apparatus, the sensing element enables a detecting signal and transmits it to the controller, and subsequently, the controller transmits an audio signal to a speaker of the specific illumining apparatus to play audio according to the audio signal.

The invention provides another method integrated sound broadcast and illumination for playing music with the user in a living environment. The method includes the steps of: providing a plurality of illumining apparatuses, wherein each illumining apparatus includes a speaker and a sensing element; determining whether a user is opposite to one of the illumining apparatuses; and transmitting an audio signal to a speaker of a specific illumining apparatus when a sensing element of the specific illumining apparatus senses a user opposite to the specific illumining apparatus. Therefore, the speaker of the specific illumining apparatus plays audio according to the audio signal.

The system and method integrated sound broadcast and illumination according to the preferred embodiment of this invention, the above mentioned sensing element is an infrared sensor for detecting the infrared rays of human temperature. In another embodiment of this invention, the sensing element is a sound intensity sensor for detecting whether or not the intensity of detected sound is larger than a predetermined decibel. Moreover, each above mentioned illumining apparatus respectively includes a plurality of light emitting diodes. The light emitting diodes is disposed around the speaker of each of the illumining apparatuses to radiate to opposite of the illumining apparatuses.

The spirit of the invention is to integrate the speaker and the sensing system into the domestic illumining apparatus. Thus, the user can listen to the music with stereo even walk around the house if the system integrated sound broadcast and illumination of the invention is assembled. Since the speaker and illumining apparatus can be installed in the ceiling, the music is played only when the user is in front of the speaker, such that the tweeter is directly aimed at human ears. Thus, the user can enjoy the stereo even walk around the house.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a design of domestic decoration combines speaker and illumination provided by the prior art of U.S. Pat. No. 7,535,341 B2.

FIG. 2 is a three-dimensional diagram of the speaker 20 combined with illumination used by domestic sound broadcast system according to the embodiment of the invention.

FIG. 3 is a bottom views diagram of the speaker 20 combined with illumination used by domestic sound broadcast system according to the embodiment of the invention.

FIG. 4 is the first sketch diagram of domestic sound broadcast system according to the embodiment of the invention.

FIG. 5 is the second sketch diagram of domestic sound broadcast system according to the embodiment of the invention.

FIG. 6 is flow chart of the method integrated domestic sound broadcast and illumination.

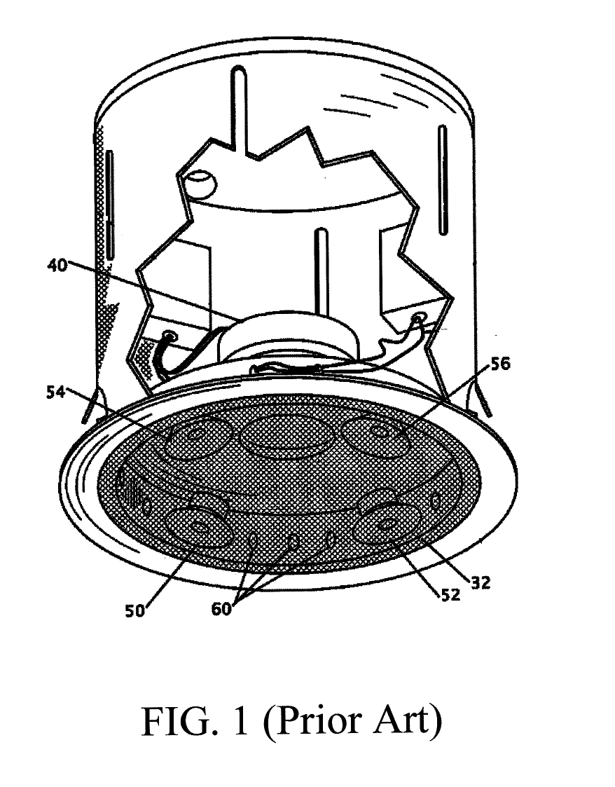

### DETAILED DESCRIPTION OF THE INVENTION

The present invention will be apparent from the following detailed description, which proceeds with reference to the accompanying drawings, wherein the same references relate to the same elements.

### The First Embodiment of the Invention

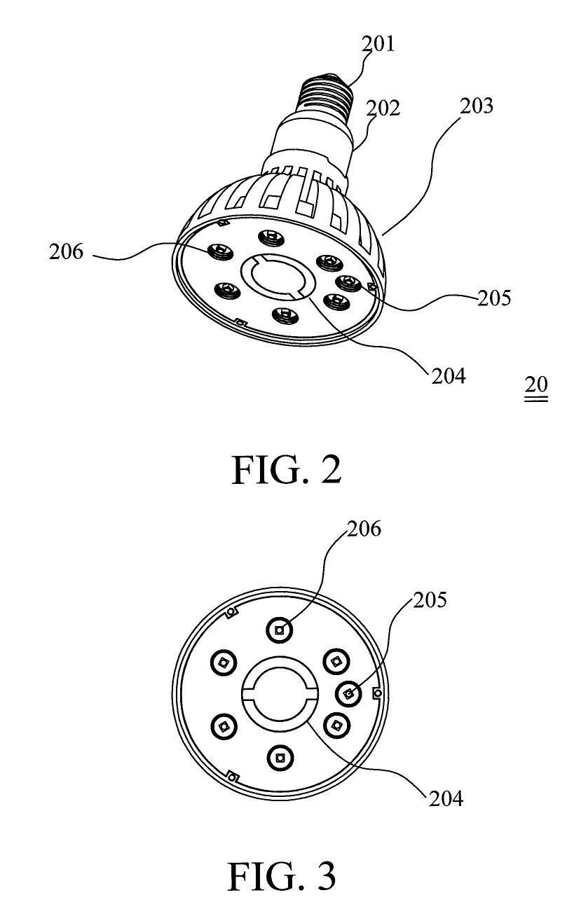

FIG. 2 is a diagram depicting a side view of the speaker 20 combined with illumination used by domestic sound broadcast system according to the embodiment of the invention. Referring to FIG. 2, the speaker is combined with illumination, wherein it includes the lamp cap 201, the body of lamp 202, the lampshade 203, the body of speaker 204, the sensor 205, and six light emitting diodes 206. FIG. 3 is a bottom views diagram of the speaker 20 combined with illumination used by domestic sound broadcast system according to the embodiment of the invention. Referring to FIG. 3, the speaker 20 combined with illumination includes the body of speaker 204, the sensor 205, and six light emitting diodes 206.

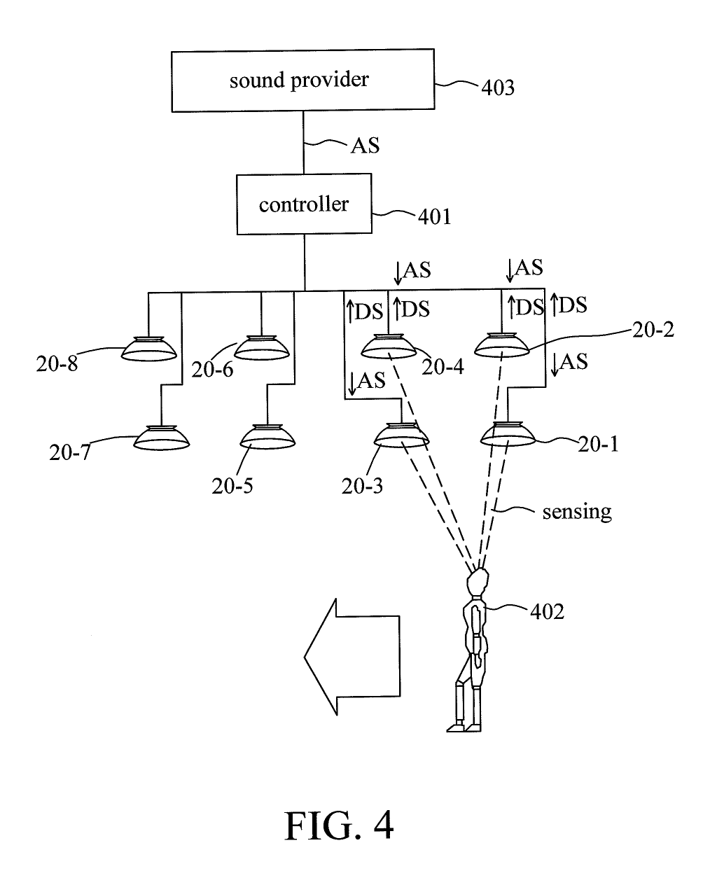

FIG. 4 is the first sketch diagram of domestic sound broadcast system according to the embodiment of the invention. Referring to FIG. 4, the domestic sound broadcast system includes 8 aforementioned speakers respectively combined with illumination 20-1, 20-2, 20-3, 20-4, 20-5, 20-6, 20-7, 20-8, and a controller 401. Each speaker 20 is coupled to controller 401. To clearly elucidate the embodiment of the invention, a walking user 402 and a sound provider 403 are extra sketched in FIG. 4. The sound provider 403 is an apparatus such as CD player, MP3 player and so forth.

It is assumed that the user had controlled the sound provider 403 to play audio. At this time, the audio signal AS would be provided to the controller 401. The sensors 205 of the aforementioned speakers combined with illumination 20-1, 20-2, 20-3, 20-4, 20-5, 20-6, 20-7, 20-8 would detect the object opposite of the speakers combined with illumination 20-1, 20-2, 20-3, 20-4, 20-5, 20-6, 20-7, 20-8. When user 402 walks around the house, he/she would be detected by the speakers combined with illumination 20-1, 20-2, 20-3, 20-4. At this time, the speakers combined with illumination 20-1, 20-2, 20-3, 20-4 would feedback to and enable a detecting signal DS to notify the controller 401 respectively. When controller 401 receives the enabled detecting signal DS respectively sending by the speakers combined with illumination 20-1, 20-2, 20-3, 20-4, it would respectively send the audio signal AS to the speakers combined with illumination 20-1, 20-2, 20-3, 20-4. Generally speaking, the audio signal AS can be separated into left channel audio signal and right channel audio signal. Thus, the speakers combined with illumination 20-1 and 20-3 may receive the right channel audio signal and play audio according to the right channel audio signal. The speakers combined with illumination 20-2 and 20-4 may receive the left channel audio signal and play audio according to the left channel audio signal.

In addition, the detecting signals DS according to the above mentioned speakers combined with illumination 20-5, 20-6, 20-7, 20-8 are not enabled because they do not sense the user 402. As a result, the controller 401 does not send audio signal AS to the above mentioned speakers combined with illumination 20-5, 20-6, 20-7, 20-8.

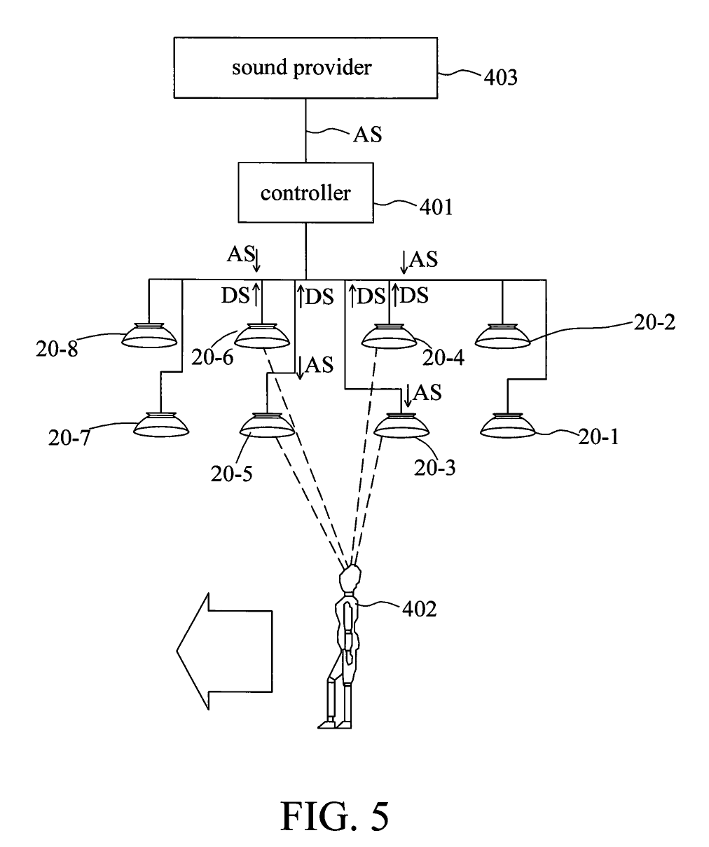

FIG. 5 is the second sketch diagram of domestic sound broadcast system according to the embodiment of the invention. In the same way, as the user keeps going and be detected by the above mentioned speakers combined with illumination 20-3, 20-4, 20-5, 20-6, the speakers combined with illumination 20-3, 20-4, 20-5, 20-6 would feedback and enable a detecting signal DS to notify the controller 401 respectively. When controller receives the detecting signal DS of the speakers combined with illumination 20-3, 20-4, 20-5, 20-6 respectively, it would send the audio signal AS to the speakers combined with illumination 20-3, 20-4, 20-5, 20-6 respectively. Thus, the speakers combined with illumination 20-3 and 20-5 receive the right channel audio signal and play audio according to the right channel audio signal. The speakers combined with illumination 20-4 and 20-6 receive the left channel audio signal and play audio according to the left channel audio signal.

In addition, the detecting signals DS according to the above mentioned speakers combined with illumination 20-1, 20-2, 20-7, 20-8 are not enabled because they do not sense the user 402. As a result, the controller 401 does not send audio signal AS to the above mentioned speakers combined with illumination 20-1, 20-2, 20-7, 20-8.

In accordance with the above mentioned embodiment, it is obviously the above mentioned system of embodiment is used for playing music with the user in a living environment. Moreover, the speakers combined with illumination 20-1, 20-2, 20-3, 20-4, 20-5, 20-6, 20-7, 20-8 will be enabled only when the user 402 is opposite to the speakers combined with illumination 20-1, 20-2, 20-3, 20-4, 20-5, 20-6, 20-7, 20-8. In addition, the speakers are in front of the user and the high pitched voice is directional. Thus, the user can enjoy the stereo.

In the abovementioned embodiment, the preferred implementation of the sensor 205 can be an infrared sensor. Since the human temperature detection technology using infrared rays is mature, the detailed description is omitted. Also, the sensor 205 could be a sound intensity sensor which is used for detecting whether or not the intensity of the detected sound is larger than a predetermined decibel.

### The Second Embodiment of the Invention

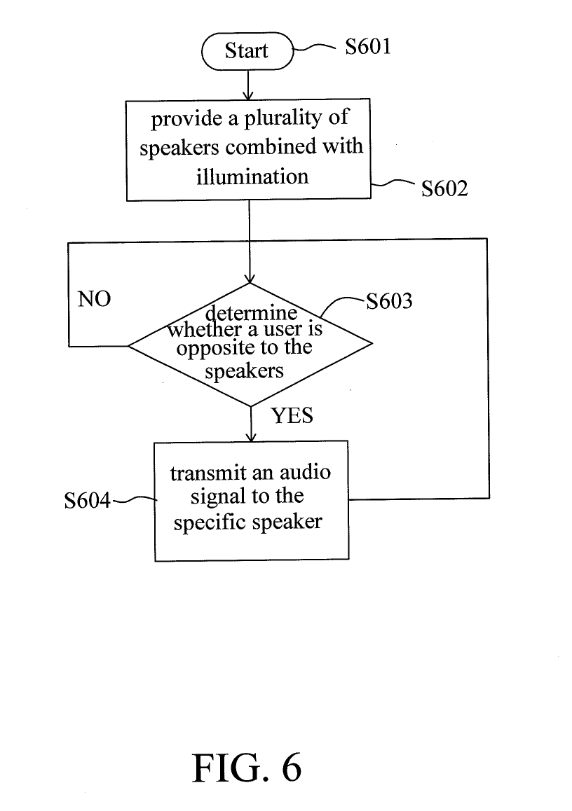

From the embodiment above, the invention can be generalized a method integrated sound broadcast and illumination and the flow chart thereof is drawn in FIG. 6. Referring to FIG. 6, the method integrated sound broadcast and illumination includes the following steps.

In step S601, the method starts.

In step S602, a plurality of illumining apparatuses, such as the speakers combined with illumination 20-1, 20-2, 20-3, 20-4, 20-5, 20-6, 20-7, 20-8 of the first embodiment of the invention, are provided.

In step S603, whether a user is opposite to one of the illumining apparatuses is determined respectively. This step is determined according to the speakers combined illumination of S602. If the user is opposite to one of the illumining apparatuses, step S604 is performed. If not, going back to S603 and resuming the determination.

In step S604, an audio signal is transmitted to a speaker of a specific illumining apparatus when a sensing element of the specific illumining apparatus senses a user opposite to the specific illumining apparatus, therefore, the speaker of the specific illumining apparatus plays audio according to the audio signal.

After S604, it will back to S603 and resume the determination.

In summary, the spirit of the present invention is to integrate a speaker and the sensing system into the domestic illumining apparatus. Thus, the user can listen to the music with stereo even walk around the house if the system integrated sound broadcast and illumination of the invention is assembled. Since the speaker and illumining apparatus can be installed in the ceiling, the music is played only when the user is in front of the speaker, such that the tweeter is directly aimed at human ears. Thus, the user can enjoy the stereo even walk around the house.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A system integrated sound broadcast and illumination, comprising:
a plurality of illumining apparatuses, wherein each illumining apparatus comprises:
a speaker, set in the illumining apparatus; and
a sensing element, set in the illumining apparatus, for sensing the passing object opposite to the illumining apparatus; and
a controller coupled to the illumining apparatuses,
wherein, when the sensing element of a specific illumining apparatus of the illumining apparatuses senses a user opposite to the specific illumining apparatus, the sensing element of the specific illumining apparatus enables and transmits a detecting signal to the controller, and the controller transmits an audio signal to the speaker of the specific illumining apparatus to play audio according to the audio signal.

2. The system integrated sound broadcast and illumination according to claim 1, wherein the sensing element is an infrared sensor for detecting the infrared rays of human temperature.

3. The system integrated sound broadcast and illumination according to claim 1, wherein the sensing element is a sound intensity sensor for detecting whether or not the intensity of detected sound is larger than a predetermined decibel.

4. The system integrated sound broadcast and illumination according to claim 1, wherein each of the illumining apparatus further comprises:
a plurality of light-emitting diodes, disposed around the speaker of each of the illumining apparatuses to radiate to opposite of the illumining apparatuses.

5. The system integrated sound broadcast and illumination according to claim 1, further comprising:
a sound provider, coupled to the controller to provide the audio signal to the controller.

6. A method integrated sound broadcast and illumination, comprising:
providing a plurality of illumining apparatuses, wherein each illumining apparatus includes a speaker and a sensing element;
determining whether a user is opposite to one of the illumining apparatuses; and
transmitting an audio signal to the speaker of a specific illumining apparatus of the illumining apparatuses when a sensing element of the specific illumining apparatus senses a user opposite to the specific illumining apparatus such that the speaker of the specific illumining apparatus plays audio according to the audio signal.

7. The method integrated sound broadcast and illumination according to claim 6, wherein the sensing element is an infrared sensor for detecting the infrared rays of human temperature.

8. The method integrated sound broadcast and illumination according to claim 6, wherein the sensing element is a sound intensity sensor for detecting whether or not the intensity of detected sound is larger than a predetermined decibel.

9. The method integrated sound broadcast and illumination according to claim 6, further comprises:
setting a plurality of light-emitting diodes disposed around the speaker of each of the illumining apparatuses to radiate to opposite of the illumining apparatus.

10. The method integrated sound broadcast and illumination according to claim 6, wherein the audio signal is provided by a sound provider.
